(19) United States
(12) Patent Application Publication
(10) Pub. No.: US 2012/0006155 A1
(43) Pub. Date: Jan. 12, 2012

(54) SHIFT TRANSMISSION

(75) Inventor: Wolfram Hasewend, Graz (AT)

(73) Assignee: Magna Powertrain AG & Co KG, Lannach (AT)

(21) Appl. No.: 12/672,534

(22) PCT Filed: Jul. 9, 2008
(86) PCT No.: PCT/EP08/05608

§ 371 Date: Mar. 5, 2010

(30) Foreign Application Priority Data
Aug. 13, 2007 (DE) 10 2007 038 175.3

(51) Int. Cl. F16H 47/02; F16D 31/02

(52) U.S. Cl. 74/730.1

(57) ABSTRACT

The invention relates to a manual transmission having an input shaft (12), one first and one second mechanical gear branch (26, 28) that may be coupled in a driving fashion on the input side with the input shaft and on the output side via various gears (G1, . . . , G7,R) with a common output shaft (40), and one first and one second hydrostatic machine (18, 18′, 20, 20′), each comprising a primary part (16), a secondary part (22, 24), and one first and one second pressure chamber. The primary part and the secondary part of each hydrostatic machine (18, 18′, 20, 20′) are rotatable relative to one another, wherein the secondary part (22) of the first hydrostatic machine (18, 18′) is operatively connected to the first mechanical gear branch (26) and the secondary part (24) of the second hydrostatic machine (20, 20′) is operatively connected to the second mechanical gear branch (28). At least one pressure control device is associated with the hydrostatic machines, by means of which the first pressure chamber of the first hydrostatic machine (18, 18′) may be hydraulically coupled to the first pressure chamber of the second hydrostatic machine (20, 20′) and the second pressure chamber if the first hydrostatic machine (18, 18′) may be hydraulically coupled to the second pressure chamber of the second hydrostatic machine (20, 20′) so as to equalize pressure between the two hydrostatic machines, particularly for shifting gears.

### CROSS REFERENCE TO RELATED APPLICATIONS

This application is a 371 National Stage of International Application No. PCT/EP2008/005608 filed Jul. 9, 2008. This application claims the benefit of German patent application No. DE 10 2007 038 175.3 filed Aug. 13, 2007. The disclosures of the above-listed applications are incorporated herein by reference.

### FIELD

This section provides a general summary of the disclosure and is not a comprehensive disclosure of its full scope or all of its features.

The invention relates to a shift transmission of a motor vehicle, having an input shaft and a first mechanical transmission branch and a second mechanical transmission branch which can be coupled drive-wise to the input shaft at the input side and via different gear stages to a common output shaft at the output side.

### BACKGROUND

This section provides background information related to the present disclosure which is not necessarily prior art.

Conventional transmissions which allow a shifting under load free of interruption of the driving power—so-called power shift transmissions—as a rule have a number of coupling elements and actuators to be able to carry out a gear stage change which is hardly noticeable for the driver and is therefore comfortable. Known power shift transmissions—dual clutch transmissions are usually used in passenger vehicles—include a plurality of components prone to wear and are therefore undesirably complex. The control of these power shift transmissions is moreover relatively complex and/or expensive.

### SUMMARY

This section provides a general summary of the disclosure and is not a comprehensive disclosure of its full scope or all of its features.

It is the underlying object of the invention to provide a shift transmission which can be shifted under load without the driving comfort being impaired by shift procedures. The components required for this and the control of the shift transmission should be as simple and as robust as possible. The shift transmission should furthermore be designed such that a plurality of driving conditions of the vehicle can be managed without special components being required for this purpose.

The shift transmission in accordance with the invention has, as initially described, a first mechanical transmission branch and a second mechanical transmission branch which can be connected drive-wise to the input shaft at the input side and via different gear stages to a common output shaft at the output side. The shift transmission furthermore includes a first hydrostatic machine and a second hydrostatic machine which each have a primary part, a secondary part and a first pressure space and a second pressure space, wherein the primary part and the secondary part of the respective hydrostatic machine are rotatable relative to one another. The secondary part of the first hydrostatic machine is operatively connected to the first mechanical transmission branch and the secondary part of the second hydrostatic machine is operatively connected to the second mechanical transmission branch. At least one pressure control device is associated with the hydrostatic machines, by means of which the first pressure space of the first hydrostatic machine can be selectively hydraulically coupled with the first pressure space of the second hydrostatic machine and, hydraulically separately therefrom, the second pressure space of the first hydrostatic machine can be selectively hydraulically coupled with the second pressure space of the second hydrostatic machine in order to bring about a pressure balance between the two hydrostatic machines—in particular for a gear stage change.

The shift transmission in accordance with the invention thus includes two separate mechanical transmission branches, in particular transmission branches having stand gears or epicycle gears which are each provided for the formation of specific gear stages. For example, the odd gear stages can be formed with the first transmission branch, whereas the second transmission branch is provided for the realization of the even gear stages and of the reverse gear.

The shift transmission in accordance with the invention furthermore includes a first hydrostatic machine and a second hydrostatic machine which are each associated with one of the two transmission branches. The drive-wise coupling of the input shaft to the respective transmission branch can be controlled by the hydrostatic machines, i.e. the driving torque of the input shaft can be transferred as required to the output shaft via one of the transmission branches or—in particular on a gear stage change—via both transmission branches simultaneously. For this purpose, the secondary part of the first hydrostatic machine is operatively connected to the first mechanical transmission branch—that is, for example, directly rotationally fixedly connected or indirectly connected via a transmission—whereas the secondary part of the second hydrostatic machine is operatively connected to the second mechanical transmission branch.

The driving torque transferred from the input shaft to the mechanical transmission branch is a function of the fluid pressures present in the pressure spaces of the hydrostatic machines. The degree of the coupling between the respective primary parts and the secondary parts can be modified by an intervention in the hydraulic system of the hydrostatic machines. In other words, the degree of the coupling depends on the fluid throughput, i.e. on the quantity or on the volume of the fluid flowing through the respective hydrostatic machine per time unit. The fluid throughput is in turn a function of the difference between the rotational speed of the respective primary part and the rotational speed of the corresponding secondary part as well as of the quantity of the hydraulic fluid flowing through the hydrostatic machine per revolution of the secondary part relative to the primary part.

On a gear stage change, the torque transfer must be transposed from one transmission branch to the other transmission branch and the rotational speeds of the secondary parts relative to the primary parts of the respective hydrostatic machine have to be varied. The control of the gear stage change takes place via the pressure control device by means of which the hydrostatic machines can be hydraulically coupled to one another in order to bring about a pressure balance between the two hydrostatic machines—for example for a gear stage change. The pressure level of the one hydrostatic machine is raised by such a pressure balance, whereas the pressure level of the other hydrostatic machine is lowered, whereby—as described above—the degree of the coupling is increased or reduced. The consequence is an—at least part—transposition of the torque transfer from one transmission branch to the other transmission branch. So that this pressure balance influences the torque transfer via the two mechanical transmission branches in the desired sense, the connection of the respective first pressure spaces to one another and the connection of the respective second pressure spaces to one another are hydraulically separate from one another.

The two hydraulic motors are in particular hydraulically coupled to one another by means of the pressure control device such that the one hydrostatic machine hydraulically drives the other hydrostatic machine. A difference in rotational speed between the primary part and the secondary part of the named other hydrostatic machine (that is of the driven hydrostatic machine) can hereby be actively brought about or at least supported. The two hydrostatic machines can preferably be directly hydraulically coupled to one another, i.e. without a direct restriction of the hydraulic fluid exchanged between the hydrostatic machines, and in particular without interposed check valves or the like.

Since the respective mechanical transmission branch is only connected to a secondary part of the respective hydrostatic machine, said secondary part being able to be designed with a small radial extent, the respective mechanical transmission branch has a comparatively small moment of inertia. The respective secondary part can, for example, be a rotor. Gear stage changes can hereby be carried out particularly fast and cost-effective synchronization devices with a low torque capacity can be used in the mechanical transmission branches.

The hydraulic coupling of the hydrostatic machines in addition enables an almost loss-free change in the transmission path of the driving torque since only flow resistances occur in the hydraulic system of the hydraulic coupling. Complex and/or expensive and wear-prone friction clutches and their actuator systems—such as in conventional dual clutch systems, for example—are therefore omitted. In addition, with the shift transmission in accordance with the invention, the heat output occurring in the transmission on a start-up procedure due to a high speed of rotation difference between the input shaft (engine speed) and the output shaft (equal to zero when the vehicle is stationary) can be led off by the hydraulic fluid and can be supplied, where necessary, to a cooling device. The fluid effecting the mechanical coupling hereby thus simultaneously acts as a coolant, which substantially simplifies the design of the cooling of the transmission since the coolant pump can be omitted. In addition, a plurality of driving and shifting situations can be realized by a suitable coupling of the two hydrostatic machines without additional cost-raising components being necessary. The control of the shift transmission in accordance with the invention can be based on a hydraulic control which is simple to realize.

In accordance with an embodiment of the shift transmission, selectively one of the hydrostatic machines can be hydraulically blocked by means of the pressure control device in order to connect the secondary part to the primary part of the respective hydrostatic machine in a substantially rotationally fixed manner, that is without significant slip. On such a block, the fluid flow flowing through the hydrostatic machine is interrupted, whereby a hydrostatic pressure is built up in the interior of the hydrostatic machine which prevents a relative movement between the primary part and the secondary part. The hydrostatic machine is then hydraulically blocked by a type of “standing liquid column” and the secondary part is connected to the primary part in an almost rotationally fixed manner. A slight slip between the respective secondary part and the primary part can in this respect occur, for example, due to leaks. Such a slight slip can even be desired under certain circumstances, in particular to prevent a mutual mechanical deformation of the components—so-called “digging in” or hammering in” under high permanent load (for example long constant travel without gear stage change).

Provision can furthermore be made that selectively one of the hydrostatic machines can be hydraulically short-circuited by means of the pressure control device in order to decouple the secondary part from the primary part of the respective machine, that is to cancel the drive connection or coupling otherwise operative between the secondary part and the primary part. A hydraulic short-circuit is to be understood as a substantially direct coupling of the two pressure spaces of the respective machine. There is thereby therefore no pressure difference or only a minimal pressure difference between the two pressure spaces of the hydrostatic machine so that the secondary part is substantially—apart from flow losses of the hydraulic fluid—freely rotatable with respect to the primary part. On a speed of rotation difference between the primary part and the secondary part, the fluid is accordingly substantially directly—and thus almost free of power loss—conveyed from one pressure space of the hydrostatic machine into its other pressure space. The coupling effect between the secondary part and the corresponding primary part is accordingly sufficiently small.

This situation can, for example, be desired when the corresponding mechanical transmission branch should be decoupled, i.e. when no torque should be transferred from the input shaft to the output shaft via this transmission branch—or via one of its gear stages.

The pressure control device can thus be controllable such that a driving torque transferred via the input shaft is transferred in accordance with a selected gear stage only to the first mechanical transmission branch or in accordance with another selected gear stage only to the second mechanical transmission path. Provision can, however, also be made that the driving torque—in particular for a gear stage change—is transferred or distributed at least at times onto the two mechanical transmission paths.

The transfer of the driving torque in equal or unequal parts to the two mechanical transmission branches can be utilized for the production of a plurality of different transmission ratios depending on which gear stages of the two mechanical transmission branches are selected. In other words, the driving torque can be variably distributed between the mechanical transmission branch by a corresponding control of the hydraulic coupling of the hydrostatic machines by means of the pressure control device—and optionally by a corresponding control of the hydrostatic machines themselves.

The secondary parts of the hydrostatic machines are advantageously connected drive-wise to the respective mechanical transmission branch without interposition of friction clutches, whereby components are saved and the control of the shift transmission is simplified.

In accordance with an embodiment of the shift transmission, each of the two hydrostatic machines can selectively be operated as a hydrostatic pump or as a hydrostatic motor. This means that such a hydrostatic machine can convey hydraulic fluid from one pressure space into the other pressure space on the presence of a speed of rotation difference between the primary part and the secondary part, with the conveying quantity and conveying direction substantially depending on the speeds of rotation and the sense of rotation of the primary part and of the secondary part. In this situation, the hydrostatic machine is thus operated as a hydrostatic pump, with the fluid pressure in the named one pressure space being smaller than in the named other pressure space. The named one pressure space in this respect forms a suction region, whereas the named other pressure space forms a pressure region.

In the opposite case, on the presence of a difference of the fluid pressures present in the two pressure spaces, a relative movement between the primary part and the secondary part is generated by a suitable control of valves of the hydrostatic machine. In this case, the hydrostatic machine thus acts as a hydrostatic motor which generates a mechanical torque, i.e. the secondary part is, for example, drive to make a rotational movement relative to the primary part. The pressure relationships are then converse to those described for the operation as a pump, i.e. there is a higher fluid pressure in the “suction region” than in the “pressure region”.

In order to be able to operate the respective hydrostatic machine selectively as a pump or as a motor, the respective hydrostatic machine can have at least one first valve which enables a connection to the first pressure space of the respective hydrostatic machine as well as at least one second valve which enables a connection to the second pressure space. The named first valve and the named second valve can in this case be actively opened or closed by means of the named pressure control device or by means of another control device. They are preferably switch valves.

In the aforesaid further development having first and second valves, the already explained hydraulic blocking of one of the hydrostatic machines can also take place by corresponding closing of the at least one first valve and/or of the at least one second valve. The already explained hydraulic short-circuiting of one of the hydrostatic machines can also take place with multi-piston machines by opening the at least one first valve and additionally the at least one second valve.

In accordance with a further development of the shift transmission, one of the two hydrostatic machines is operated at least at times by means of the pressure control device as a hydraulic pump, whereas the other hydrostatic machine is simultaneously operated as a hydrostatic motor which is hydraulically driven by the one hydrostatic machine. Such a configuration can in particular be advantageous for the carrying out of a gear stage change. This form of control enables a particularly efficient division of the driving torque to the two mechanical transmission branches. The division can be varied in dependence on the requirement profile, whereby an efficient and matched driving torque transfer can be provided for a plurality of driving situations.

It is preferred if a control unit is provided by means of which the pressure control device and a gear stage actuator can be controlled for a gear stage change, when a gear stage of the first mechanical transmission branch is selected, such that a gear stage of the second mechanical transmission branch is selected, while the first hydrostatic machine is hydraulically blocked and the second hydrostatic machine is hydraulically short-circuited; then the first and second hydrostatic machines are hydraulically coupled to one another and the speed of rotation of the input shaft is reduced, with a pressure balance between the two hydrostatic machines taking place and the driving torque being transmitted at least partly via the second mechanical transmission branch; and then the first and second hydrostatic machines are hydraulically decoupled from one another, with the second hydrostatic machine being hydraulically blocked and the first hydrostatic machine being hydraulically short-circuited so that the driving torque is substantially completely transferred by the second mechanical transmission branch.

In an advantageous further development of this embodiment, the speed of rotation of the input shaft is controllable such that it is reduced, while the first and second hydrostatic machines are hydraulically decoupled from one another. The loads on the mechanical and hydraulic components of the shift transmission which arise are thereby reduced and a “smoother” gear stage change can be carried out.

The reduction in the input shaft speed of rotation is required when “switching up”, i.e. on an increase in the gear stage. Analogously, on a “shifting down”, i.e. on a lowering of the gear stage, the speed of rotation of the input shaft is increased.

In a further embodiment of the shift transmission in accordance with the invention, the geometry of the hydrostatic machines is variable such that a volume throughput of the hydraulic fluid can be controlled by the respective hydrostatic machine per revolution of the secondary part relative to the primary part. In other words, for example, the volume of pistons of a hydrostatic machine is variable and can be matched to the respective requirements. The quantity of the hydraulic fluid flowing through the hydrostatic machine can thereby be changed without the speed of rotation difference between the primary part and the secondary part having to be changed. The named volume throughput per revolution is also called the injection volume.

Provision can be made with a shift transmission having variable hydrostatic machines that the geometry of the hydrostatic machines can be controlled by the pressure control device such that the volume throughput per revolution of the second hydrostatic machine is smaller before the hydraulic coupling of the hydrostatic machines than the corresponding volume throughput per revolution of the first hydrostatic machine. The geometry of the hydrostatic machines is furthermore controlled in this embodiment such that, during the hydraulic coupling of the hydrostatic machine, the volume throughput per revolution of the second hydrostatic machine is increased and the volume throughput per revolution of the first hydrostatic machine is reduced until the driving torque is primarily or substantially completely transferred via the second mechanical transmission branch. The torque transfer from one transmission branch to the other transmission branch becomes more effective and “smoother” by such a procedure.

For example, in a coupled state of the hydrostatic machines, the fluid throughput capacity of the second hydrostatic machine is increased—starting from a low capacity—until the first and second hydrostatic machines have the same fluid throughput capacity. The fluid throughput capacity of the second hydrostatic machine is subsequently reduced.

In accordance with a further embodiment, the first pressure space of the first hydrostatic machine can be hydraulically coupled to the second pressure space of the second hydrostatic machine by means of the pressure control and the second pressure space of the first hydrostatic machine can be coupled to the first pressure space of the second hydrostatic machine. Such a “cross-over” coupling of the hydrostatic machines enables the production of additional operating states—optionally in conjunction with a variable geometry of the hydrostatic machines. For example, with a simultaneously selected first forward gear stage and reverse gear stage, the realization of a “geared neutral” function is thereby made possible (corresponding to a ratio of infinity) and thus a “hill hold” function.

The geometry of the hydrostatic machines can be fixed or set—in the case of a variable geometry—such that in a condition in which two gear stages having a transmission ratio in the same sense or in the opposite sense are selected and the first pressure space of the first hydrostatic machine is hydraulically coupled to the second pressure space of the second hydrostatic machine and the second pressure space of the first hydrostatic machine is hydraulically coupled to the first pressure space of the second hydrostatic machine different positive or negative transmission ratios can be produced between the input shaft and the output shaft.

For example, a “hydraulic reverse gear” can be formed by the fixing or setting of different fluid throughput capacities of the two hydrostatic machines in that two forward gear stages are selected. In addition the production of a “geared creep” is possible. For this purpose, it is necessary—as with the “geared neutral” setting—that the first forward gear stage and the reverse gear stage are selected, with fluid throughput capacities of the two hydrostatic machines of different sizes being selected for the geared creep.

In accordance with an embodiment, the respective primary part and the respective secondary part of the hydrostatic machines are rotatable. In this configuration, the hydrostatic machines act as “hydrostatic clutches” between the input shaft and the transmission branches. For example, on a blocking of one of the hydrostatic machines, a rotational movement of the rotatable primary part driven by the input shaft is transferred via the secondary part to the respective transmission branch.

A constructionally particularly advantageous further development provides that the primary part of the first hydrostatic machine is rotationally fixedly connected to the primary part of the second hydrostatic machine, is in particular designed in one piece with the primary part of the second hydrostatic machine.

A respective differential gear can be associated with the two mechanical transmission branches. In this respect, an input of the respective differential gear is coupled to the input shaft, whereas a first output of the respective differential gear is coupled to the secondary part of the respective hydrostatic machine. A second output of the respective differential gear is coupled to the respective mechanical transmission branch. In this embodiment, the hydrostatic machines are configured as “hydrostatic brakes” which can support the driving torque. For example, on a blocking of one of the hydrostatic machines, the first output of the differential gear is blocked. The transmission branch is thereby driven by the input shaft at a rotational speed which corresponds to the ratio of the differential gear. If, however, the design of a speed of rotation difference between the primary part and the secondary part is made possible, the torque transfer and the rotational speed ratio between the mechanical transmission branch and the input shaft can be influenced.

The respective differential gear is in particular formed by a planetary transmission. Provision can furthermore be made to arrange the primary parts of the hydrostatic machines stationary. This embodiment is particularly simple in a construction respect since it is not the whole hydrostatic machine which rotates, which also simplifies its control.

In accordance with a further development of the shift transmission in accordance with the invention having differential gears, the input shaft and the first and second mechanical transmission branches are permanently coupled to one another, with—as explained above—the driving torque transferred via this type of coupling likewise being variable and depending on the operating state of the hydrostatic machines.

It is furthermore preferred if the named primary part is a housing of the hydrostatic machine. The secondary part can be formed by a rotor. Alternatively to this, the named primary part can, if it is arranged rotatably, be a further rotor of the respective hydrostatic machine.

It has proved to be particularly efficient if at least one of the two hydrostatic machines can be connected to at least one further component of a hydraulic system. For example, the transferred torque can be determined in a simple manner by a pressure measurement. In addition, in specific driving states, hydraulic fluid can be used by a connection to the hydrostatic machines for the actuation of further vehicle control components—for example of an all-wheel clutch.

A connection line can be associated with the hydrostatic machines, with a controllable restrictor valve being arranged in its extent to restrict the fluid throughput of the respective hydrostatic machine. In other words, the fluid throughput can be influenced for specific driving conditions by the controllable restrictor, whereby the torque transmitted via the corresponding hydrostatic machine can be controlled. This in particular simplifies the control of the torque transfer from the input shaft to the mechanical transmission branch in a start-up situation.

A common connection line and a common restrictor valve are preferably associated with the hydrostatic machines. A cooling device for the cooling of the hydraulic fluid can be arranged in the extent of the connection line, whereby the fluid flowing through the restrictor can be cooled in an efficient manner. Particularly with large speed of rotation differences between the primary part and the secondary part—as on a start-up procedure, for instance—a substantial quantity of waste heat is produced which can thus be efficiently led off.

Further areas of applicability will become apparent from the description provided herein. The description and specific examples in this summary are intended for purposes of illustration only and are not intended to limit the scope of the present disclosure.

### DRAWINGS

The drawings describe herein are for illustrative purposes only of the selected embodiments and not all possible implementations and are not intended to limit the scope of the present disclosure.

FIG. 1 is a schematic representation of an embodiment of the shift transmission in accordance with the invention;

FIG. 2 is a section through a radial piston machine;

FIGS. 3 to 5 illustrate different embodiments of a pressure control device of an embodiment of the shift transmission in accordance with the invention;

FIGS. 6 to 8 are schematic representations of different further embodiments of the shift transmission in accordance with the invention; and

FIG. 9 discloses a planetary gear arrangement which serves for the coupling of the input shaft with the hydrostatic machines and the mechanical transmission branches.

### DETAILED DESCRIPTION

Exemplary embodiments of the present invention will now be more fully described with reference to the accompanying drawings.

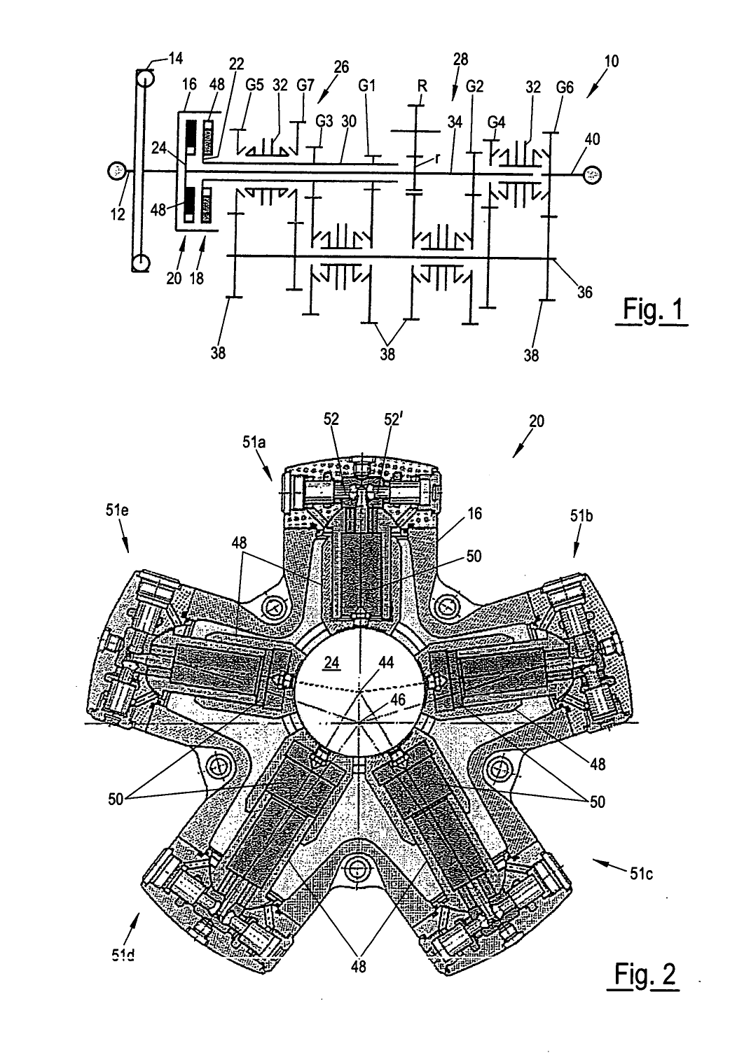

FIG. 1 shows an embodiment of a shift transmission 10 in accordance with the invention. The left hand side of the shift transmission 10 facing a drive unit, not shown, of a vehicle includes an input shaft 12 which is driven to make a rotational movement by the drive unit. Rotational irregularities are conducted from the drive unit—for example an internal combustion engine—into a powertrain of the vehicle including the shift transmission 10 and result in the creation of rotational vibrations. The input shaft 12 has a torsion damper 14 to reduce the rotational vibrations.

The input shaft 12 is connected at the transmission side to a first and a second hydrostatic machine 18, 20 which have a common housing 16. The housing 16 is rotationally fixedly coupled to the input shaft 12.

The machines 18, 20 each have a rotor 22 and 24 respectively (see also FIG. 2), with the rotor 22 being rotationally fixedly connected to a first mechanical transmission branch 26, whereas the rotor 24 is rotationally fixedly connected to a second mechanical transmission branch 28.

The first transmission branch 26 includes a hollow shaft 30 which is permanently rotationally fixedly connected to the transmission gears G1 and G3. Further transmission gears G5 and G7 can be selectively connected rotationally fixedly to the hollow shaft 30 by a synchronization device 32.

In an analog manner, the second mechanical transmission branch 28 includes a transmission shaft 34 which is in permanent rotationally fixed communication with a transmission gear G2 and which can selectively be coupled to a transmission gear G4 via a synchronization device 32. In addition, a gear r is fastened to the transmission shaft 34 and is in engagement with a transmission gear R by which a reverse gear can be formed.

The shift transmission 10 furthermore includes a back gear shaft 36 which has eight gears 38. Of the eight gears 38, the middle four gears 38 can be selectively rotationally fixedly coupled to the back gear shaft 36 by synchronization devices 32. The remaining four gears are permanently rotationally fixedly coupled to the back gear shaft 36.

By actuation of a respective gear stage actuator (not shown), the synchronization devices 32 can be axially displaced in order to form seven forward gear stages (in accordance with the gears G1 to G6) and one reverse gear (R) in a known manner. For the formation of the first gear stage, the left hand synchronization device 32 of the back gear shaft 36 is brought into engagement with the gear 38 of the back gear shaft 36 adjacent to the right hand side so that a rotational movement of the hollow shaft 30 can be transmitted via the transmission gear G1 to the back gear shaft 36 and finally via the transmission gear G6 to an output shaft 40 of the shift transmission 10 and thus to further elements of the powertrain (not shown) of the vehicle. The further gear stages of the shift transmission 10 are formed in an analog manner.

It will be explained in the following how a driving torque of the input shaft 12 is transferred in a suitable manner with the shift transmission 10 to the hollow shaft 30 and/or to the transmission shaft 34.

If, for example, an even gear stage (second, fourth or sixth gear) or the reverse gear is selected, the torque of the input shaft 12 has to be transferred to the transmission shaft 34. If an odd gear stage has been selected, the transfer of the driving torque to the hollow shaft 30 is necessary. If a change of the gear stage should be carried out, a change of the transmission path of the torque must also take place. In this respect, a portion of the driving torque is transferred via both mechanical transmission branches 26, 28 at times, with the respective transferred portion of the driving torque changing during the gear stage change. Such a gear stage change should also be possible and should run as smoothly as possible under load so that the driving comfort is not reduced by jerky movements of the vehicle or similar negative accompanying phenomena.

This is achieved by the use of the two hydrostatic machines 18, 20. The rotor 24 can, for example, be blocked with respect to the housing 16 by the control of the machines 18, 20, whereas the rotor 22 associated with the transmission branch 26 is decoupled from the housing 16. In this case, the torque of the input shaft 12 is transferred completely to the transmission shaft 34 via the machine 20. It is, however, also possible that the hydrostatic machines 18, 20 are controlled such that the rotors 20, 24 are only partly coupled to the rotational movement of the housing 16. No friction clutches are thus required to be able to carry out and vary the torque transfer to the mechanical transmission branches 26, 28. This division only takes place via the machines 18, 20 which are substantially identical in function.

A machine type suitable for use in the shift transmission 10 is represented, for example, by hydrostatic radial piston machines. The function of a radial piston machine will be explained with reference to FIG. 2 in the following which shows a section through a radial piston machine 20. The radial piston machine 20 shown can be operated both as a pump and as a motor. In other words, it can be used, on the one hand, for the conveying of a hydraulic fluid; on the other hand, it can generate a relative rotational movement between the housing 16 and the rotor 24 by controlled pressure application.

The radial piston machine 20 shown includes the rotor 24 which has a circular outline in the region of the machine 20, with the center 44 of the circular shape being offset with respect to the common axis of rotation 46 of the housing 16 and of the rotor 24 or of the associated transmission shaft 34. In other words, the rotor 24 is an eccentric element. The rotor 24 is in communication with five pistons 48 which each have a piston space 50. On a rotation of the rotor 24 relative to the housing 16, the volumes of the piston spaces 50 are alternately increased and decreased in size. In other words, a hydraulic fluid which first flows in through a valve 52 is subsequently expelled again through a further valve 52′ of the respective piston 48 by the rotational movement of the rotor 22 relative to the housing 16. A hydraulic fluid is thus conveyed from a first pressure space (not shown) in communication with the valve 52 to a second pressure space (not shown) which is in communication with the valve 52′.

If the radial piston machine 20 is operated as a pump, hydraulic liquid is initially sucked into the piston space 50 of a cylinder 51 a of the radial piston machine 20 in the state shown in FIG. 2 on a rotation of the rotor 24 counter clockwise since the piston space 50 initially has a minimal volume. The pistons 48 of the cylinders 51b and 51c are also in the suction phase. If a maximum volume of the respective piston space 50 has been reached, the volume of the piston space 50 is now reduced again, that is the fluid pressure is increased, due to the effect of the rotation of the rotor 24. From a specific rotational position of the rotor 24 or from a specific threshold of the fluid pressure onward, the valve 52′ is opened and the hydraulic fluid is output into the pressure space, not shown.

FIG. 2 was described by way of example under the assumption that the housing 16 is not rotatably journalled. It can, however, easily be seen that the conveyed quantity of the hydraulic fluid only depends on the geometry of the piston spaces 50 and on a speed of rotation difference between the housing 16 and the rotor 24. In other words, no hydraulic fluid is conveyed when the housing 16 and the rotor 24 rotate at the same speed.

If the radial piston machine 20 is operated as a motor, a rotational movement is produced, or at least supported, by a pressure difference in the pressure spaces, not shown, with the above-named functional principle applying in an analog manner. However, the pressurized hydraulic fluid must then be fed into the respective piston space 50 by a suitable control of the respective valve 52 of the cylinders 51a-e on a suitable position of the rotor 24. On pressure reduction, the volume of the piston space 50 is increased, whereby the rotor 24 has a torque applied by the piston 48. Subsequently, the valve 52′ is opened to allow the hydraulic fluid to escape at a now lower pressure.

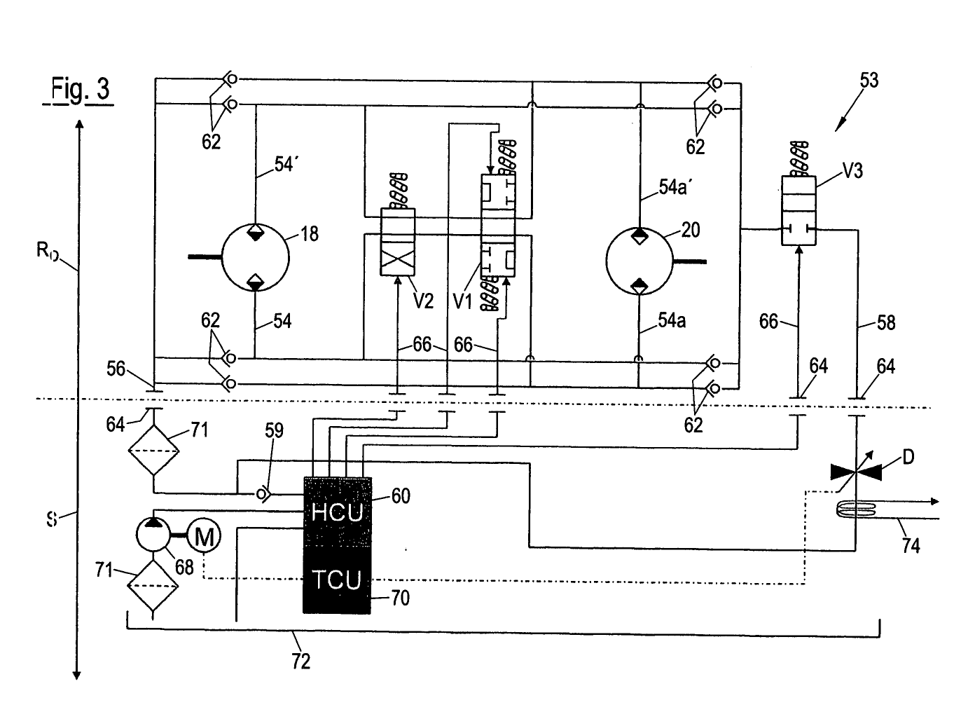

It must still be noted with respect to FIG. 2 that a radial piston machine 18 of substantially the same type can be arranged axially offset to the radial piston machine 20 shown, with the two radial piston machines 18, 20 in particular being able to have a common housing 16 (cf. FIG. 1). Generally, other types of hydrostatic machines 18, 20 can also be used. In the use of the hydrostatic machine 20 described here, not only the conveying of a hydraulic fluid or the drive of a shaft is of central importance, but also a controlled coupling of the housing 16 with the rotors 20, 24. This can be realized in that the flow of hydraulic fluid through the hydrostatic machine 18, 20 or the pressure of the hydraulic fluid is controlled. If the hydrostatic machine 20 can namely not output any hydraulic fluid through the valve 52, the rotor 24 can no longer rotate with respect to the housing 16. The coupling is cancelled in that the throughput of the hydraulic fluid is permitted again. The distribution of the driving torque of the input shaft 12 in accordance with FIG. 1 transferred via the individual mechanical transmission branches 26, 28 is thus substantially based on a variation of the pressure of the hydraulic fluid. A schematic view of an embodiment of a pressure control 53 is shown in FIG. 3.

FIG. 3 shows the machines 18, 20. The machines 18, 20 are each connected to pressure lines 54 and 54′ and 54a and 54a′ respectively. The hydrostatic machines 18, 20 can be hydraulically coupled in that a connection is established between the pressure lines 54, 54′ and the pressure lines 54a, 54a′. This takes place by two valves V1, V2. The valve V1 is here a 4/3 way valve and the valve V2 is a 4/2 way valve.

The valve V1 has three switch states. In a first switch state (lowest section of the valve V1 in accordance with FIG. 3), the pressure lines 54 and 54′ of the machine 18 are blocked, whereas the pressure lines 54a and 54a′ of the machine 20 are connected to one another. In the second switch state of the valve V1 (shown in FIG. 3), the pressure line 54′ is connected to the pressure line 54′ and the pressure line 54 is connected to the pressure line 54a. The third switch state is the converse of the first state, i.e. the pressure lines 54a and 54a′ are blocked, while the pressure lines 54 and 54′ are connected to one another (topmost section of the valve V1 in accordance with FIG. 3).

The valve V2 has two switch states, with the second switch state of the valve V2 in particular being of importance in the aforesaid second switch stage of the valve V1. A “cross-over” connection or coupling inversion of the hydrostatic machines 18, 20 can then be established by the valve V2. In this case, the pressure line 54 is in communication with the pressure line 54a′, whereas the pressure line 54′ is in communication with the pressure line 54a. The first switch state of the valve V2 does not produce this effect, but rather only serves for the “normal” coupling of the hydrostatic machines 18, 20.

In other words, a block or an idling of one of the hydrostatic machines 18, 20 can be effected by the valves V1, V2, with—as already described above—the respective mechanical transmission branch 26, 28 being decoupled from the input shaft 12 on an idling of the hydrostatic machines 18, 20, i.e. on a short-circuit of the pressure lines 54, 54′ or 54a, 54a′ respectively associated with the corresponding hydrostatic machine 18, 20. On a block of the pressure lines 54, 54′ or 54a, 54a′ respectively, in contrast, a substantially slip-free coupling of the drive shaft 12 to the corresponding mechanical transmission branch 26, 28 is brought about. A pressure balance—and thus a torque transfer—can be established between the hydrostatic machines 18, 20 by a hydraulic coupling by the second switch position of the valve V1, which is significant within the framework of a gear stage change, for example, as will be described in the following.

The hydraulic system described above for the hydraulic coupling of the hydrostatic machines 18, 20 is in communication via a supply line 56 and an outflow line 58 as well as a check valve 59 with a hydraulic control unit (HCU) 60. Check valves 62 in the pressure lines 54, 54′, 54a, 54a′ ensure that no hydraulic fluid can flow back into the supply line 56 or no hydraulic fluid can flow back out of the outflow line 58 into the aforesaid part of the hydraulic coupling system. The supply line 56 and the outflow line 58 have rotary leadthroughs 64. The rotary leadthroughs 64 are necessary since the machines 18, 20, the pressure lines 54, 54′ and 54a, 54a′ respectively associated with them and the valves V1, V2 rotate (rotation region Ro above the dashed line), whereas the remaining components, still to be described in the following in part, of the control 53 are arranged stationary (stationary region S beneath the dashed line).

Control lines 66 can be pressurized by the hydraulic control unit 64 to control the valves V1 and V2, on the one hand, and also a valve V5, on the other hand—whose function will be explained in the following—by means of a control pressure.

The hydraulic control unit 60 is supplied with pressurized hydraulic fluid through a pump 68 in communication with a motor M, with the motor M being electrically controlled by a transmission control unit (TCU) 70. The pump 68 takes the hydraulic fluid via a hydraulic fluid filter 71 from a sump 72 which is also in communication with the hydraulic control unit 60.

If, for example, the first gear stage is selected and if the driving torque of the drive unit of the vehicle should therefore be transmitted completely via the first mechanical transmission path 26, the rotor 22 of the first hydrostatic machine 18 rotationally fixedly connected to the hollow shaft 30 must be blocked with respect to the housing 16 rotationally fixedly connected to the input shaft 12 (cf. FIG. 1). For this purpose, the valve V1 shown in FIG. 3 must be in the explained first switch state. The hydrostatic machine 18 is then blocked due to the blocking of the pressure lines 54, 54′ so that the rotor 22 rotates together with the housing 16. The hydrostatic machine 20 is, in contrast, in a short-circuited state so that its two pressure spaces are substantially in direct communication with one another. With a speed of rotation difference between the rotor 24 and the housing 16, only hydraulic fluid is thus circulated and is conveyed substantially loss-free from one pressure space into the other, which corresponds to an idling of the hydrostatic machine 20.

Starting from this state, the operation of the shift transmission 10 should now be described with reference to FIGS. 1 to 3 by way of example with respect to a change from the first gear stage into the second gear stage.

Since the second hydrostatic machine 20 is short-circuited, the new gear stage can be selected by means of the associated synchronization device 32, i.e. the transmission gear G2 of the second mechanical transmission branch 28 is rotationally fixedly coupled to the transmission shaft 34. Due to the transmission ratio of the second gear step—which is lower in comparison with the transmission ratio of the first gear stage—there is a speed of rotation difference between the rotational speed of the input shaft and the rotational speed of the second mechanical transmission branch 28, with the hydrostatic machine 20 acting as a hydrostatic pump. No driving torque is yet transferred to the mechanical transmission branch 28 at this moment in time due to the short-circuit of the lines 54a and 54a′.

Then a takeover of a portion of the driving torque by the second transmission branch 28 is initiated in that the valve V2 is brought into the second switch state shown in FIG. 3. A hydraulic coupling of the two hydrostatic machines 18, 20 is thereby established. The hydraulic fluid conveyed by the hydrostatic machine 20 acting as a pump is now supplied to the machine 18 operated as a motor by an active control of the valves 52, 52′. There is initially not yet any speed of rotation difference between the housing 16 and the rotor 22 of the machine 18.

The fluid conveyed by the large pump capacity of the hydrostatic machine 20 now, however, drives the hydrostatic machine 18—with a corresponding actuation of the valves 52, 52′—whereby a lowering of the rotational speed of the input shaft and thus of the drive unit of the vehicle is supported. The lowering of the rotational speed of the drive unit is also carried out actively simultaneously. The speed of rotation difference between the housing 16 and the rotor 24 of the hydrostatic machine 20 is reduced by the lowering of the rotational speed of the input shaft 12 since the rotational speeds of the mechanical transmission branches 26, 28 are constant during the total shift procedure due to the substantially unchanging vehicle speed. This has the consequence of a lowering of the conveying capacity of the hydrostatic machine 20. In contrast to this, the speed of rotation difference between the housing and the rotor 22 of the hydrostatic machine 18 increases, whereby the drive performance of the hydrostatic machine 18 likewise falls

The falling of the capacities of the hydrostatic machines 18, 20, on the one hand, results in an increase of the torque transferred via the second transmission branch 28; on the other hand, the torque transmitted via the first transmission branch 26 reduces. This procedure continues until a pressure balance is established between the hydrostatic machines 18, 20 and a balanced state is adopted in which the driving torque is transferred via the first mechanical transmission branch 26, in one part, and via the second mechanical transmission branch 28, in the other part. If the hydrostatic machines 18, 20 are substantially identical, i.e. have substantially the same piston space geometries, an equal division of the torque transferred via the individual transmission branches 26, 28 is adopted in the balanced state.

Subsequently, the machines 18, 20 are again hydraulically decoupled from one another in that the valve V1 is brought into the explained third switch state, whereby the hydrostatic machine 18 is short-circuited and the hydrostatic machine 20 is hydraulically blocked. To avoid warping of the mechanical components of the shift transmission 10, the switching of the valve V1 is accompanied by an active rotational speed reduction of the input shaft 12 until the input shaft 12 and the second transmission branch 28 have the same rotational speed. The driving torque is now transferred substantially completely by the second mechanical transmission branch 28 with the blocking of the pressure lines 54a, 54a′. The change from the first gear stage into the second gear stage is thus concluded.

Gear stage changes between other gear stages take place in an analog manner. A gear stage change from a higher gear stage into a lower gear stage takes place substantially in the reverse order.

The shift transmission 10 makes possible—as described above—a type of gear stage change which can be controlled simply, with the gear stage change also being able to take place under load. No substantial power losses occur during the gear stage change due to the pump/motor configuration of the hydrostatic machines 18, 20. The hydrostatic machines 18, 20 rather support the gear stage changes in an advantageous manner, whereby it can be designed particularly efficiently. In addition, it becomes clear from the above descriptions that friction clutches can be completely dispensed with. Only the constructionally simple valves V1 and V2 and the hydrostatic machines 18, 20 have to be controlled in a suitable manner.

The use of hydrostatic machines 18, 20 for the coupling of the input shaft 12 and of the mechanical transmission branches 26, 28 additionally enables a plurality of advantageous further developments.

As already noted above, the outflow line 58 has the valve V3. This is generally closed during the above-described procedures. In addition, a restrictor valve D which can be regulated by the transmission control unit 70 and a cooling device 74 are arranged in the outflow line 58. These components can be utilized, for example, on a start-up of the vehicle. In this respect, the driving torque should be transferred via the first gear stage so that the first transmission branch 26 is selected and the corresponding hydrostatic machine 18 is short-circuited. The second transmission branch 28 is not selected.

In this situation, the input shaft 12—and thus the housing 16 of the hydrostatic machine 18—rotates very fast (rotational speed of the drive unit), while the selected transmission branch 26 does not show any rotation since the vehicle is stationary. A high speed of rotation difference between the housing 16 and the rotor 22 is thus present, which brings about a large conveying capacity of the hydraulically short-circuited machine 18 and results in an increased heat development there. In order gradually to increase the degree of coupling between the input shaft 12 and the selected transmission branch 26, the valve V3 is opened, with the regulable restrictor valve D being in an opened position. Expediently, the pressure lines 54, 54′ are additionally blocked (aforesaid first position of the valve V1).

The counter pressure against which the hydrostatic machine 18 has to work is increased by a gradual closing of the restrictor valve D. This counter-pressure acting against the pump capacity of the machine 18 has the result that the coupling of the rotor 22 with the housing 16 is creased. An increasing portion of the driving torque is therefore transferred to the first transmission branch 26 by the closing of the restrictor valve D and the vehicle starts up.

In other words, the counter-pressure acting against the pump power can be controlled via an intervention into the conveyed volume of the hydraulic fluid, which results in a coupling of the rotor 22 with the housing 16 since the driving torque transferred by the input shaft 12 to the mechanical transmission branches 26 is directly proportional to the fluid pressure which is effectively generated due to the conveying capacity of the hydraulic machine 18, on the one hand, and the intervention by means of the pressure control 53, on the other hand.

Start-up states can thus be realized in a simple manner by the provision of the valve V3 and of the regulable restrictor valve D without an additional start-up element being required. In addition, the heat arising in the machine 18 can be led away in an efficient manner by the cooling device 74.

The restricted hydraulic fluid can be supplied back to the hydrostatic machines 18, 20 via the supply line 56 in communication with the outflow line 58. The hydraulic control unit 60 can moreover balance any fluid losses—for example at the rotary leadthroughs 64—by hydraulic fluid conveyed from the sump 72 by means of the pump 68.

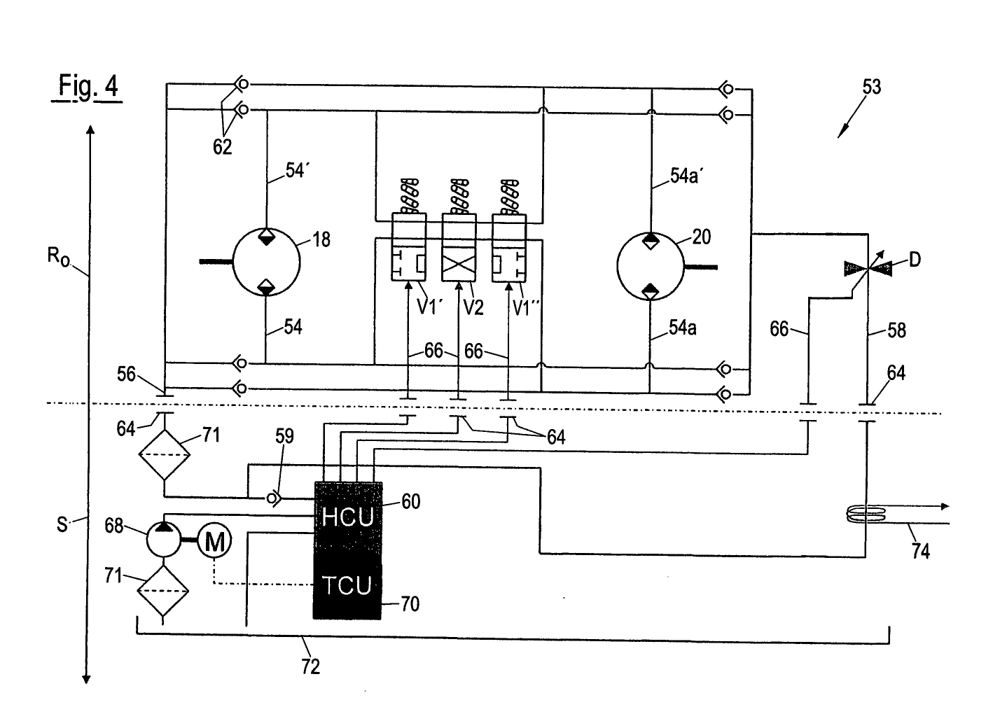

Instead of the switch valve V3 and the restrictor valve D, a single regulable valve can also be provided (proportional valve, restrictor valve), as is shown in FIG. 4.

FIG. 4 shows a further embodiment of the pressure control device 53.

Instead of the valve V1 with three possible switch states, two 2/4 way valves V1′ and V1″ are provided which each permit two switch states, namely a switch state for the connection of the pressure lines 54′ and 54a′ or 54 and 54a respectively—short circuit of one of the hydrostatic machines 18, 20—and a switch state for the block of the other hydrostatic machine 20 and 18 respectively. The valves V1′, V1″ and V2 are designed such that, on a failure of the hydraulic control unit 60 and on a subsequent drop in the control pressure in the control lines 66, the hydrostatic machines 18, 20 are automatically coupled so that, for example, an unintentional simultaneous block of both hydrostatic machines 18, 20, which is damaging for the components of the shift transmission, can be precluded. In addition, such valves V1′, V2″, V2 having two positions can be controlled in a simple manner.

In contrast to the embodiment of the pressure control 53 shown in FIG. 3, the embodiment of FIG. 4 does not have a valve V3 for the separation of the outflow lone 58 from the hydraulic system to the coupling of the hydrostatic machines 18, 20. This function is satisfied here by the restrictor valve D which is hydraulically controlled by the control line 66. The embodiment of FIG. 4 is structured more simply in an advantageous manner by the omission of the valve V3 and of an electrical control line for the control of the restrictor valve D by the transmission control unit 70—see FIG. 3, dashed line. In addition, the restrictor valve D is arranged in the rotating region Ro, whereby the advantage results that the rotary leadthrough 64 in the outflow line 58 is arranged behind the restrictor valve D in the flow direction of the hydraulic fluid. The rotary leadthrough 64 is therefore no longer part of the part of the pressure control 53 to which high pressure is applied. Leak losses are thereby minimized and the rotary leadthrough 64 can be designed in a less complex and/or expensive manner. An automatic opening of the restrictor valve D on the drop of the control pressure can be provided to bring the vehicle into a state in which the drive unit is substantially completely decoupled from the transmission branches 26, 28.

In the above descriptions, only the “parallel” position of the respective valve V2 is looked at which is shown in FIGS. 3 and 4 and which results in a connection of the pressure lines 54′ and 54a′ or 54 and 54a respectively. In specific cases, a “cross-over” coupling of the hydrostatic machines 18, 20 can also be advantageous (second switch state of V2).

If, for example, a first gear stage and the reverse gear are simultaneously selected, a torque is admittedly provided via both transmission branches 26, 28. However, the two mechanical transmission branches 26, 28 do not rotate; the vehicle is stationary. A rolling away of the vehicle when stationary or at a hill can thereby be prevented, for example (“geared neutral” or “hill hold” function). In this state, the hydrostatic machines 18, 20 are in the above-described balanced state in which the pressure balance has already taken place.

Provision can furthermore be made that the hydrostatic machines 18, 20 have a variable geometry—as variable hydrostatic machines 18′, 20′—with the piston spaces 50 of the cylinders 51a-e of the variable hydrostatic machines 18,20 being adjustable, for example, by means of wobble plates so that the throughput of the hydraulic fluid per revolution of the rotor 22 or 24 can be variably controlled—both in a pump operation and in a motor operation. Other hydrostatic machine types then the machine type discussed above with radial pistons can also do this.

Such hydrostatic machines 18′, 20′, with variable geometries make it possible that a “geared creep” can be realized with a “cross-over” coupling.

For this purpose, for example, the first gear stage and the reverse gear stage are selected and the hydrostatic machine 18′, 20′ acting as a pump has a larger conveying capacity than the machine 20′ or 18′ operated as a motor. With the balanced state being adopted in the “cross-over” configuration, torque is transmitted via both transmission branches 26, 28, with these then rotating in opposite senses. In sum, a small propulsion of the vehicle is produced and a transmission ratio can be set which is lower in amount than the transmission ratio of the smallest gear stage (G1 or R) of the mechanical transmission branches 26, 28.

If instead of the reverse gear stage a forward gear stage—for example the second gear stage—is adopted under otherwise the same conditions, i.e. differently large conveying capacities of the hydrostatic machines 18′, 20′, a drive of the vehicle likewise results due to the transmission ratios of different amounts of the selected gear stages 26, 28, said drive, however, being directed in the opposite direction—compared with the above-described case of the “geared creep”. In other words, a “hydraulic reverse gear” can thus be realized. The torques transferred via the two transmission branches 26, 28 in this respect have a different sign.

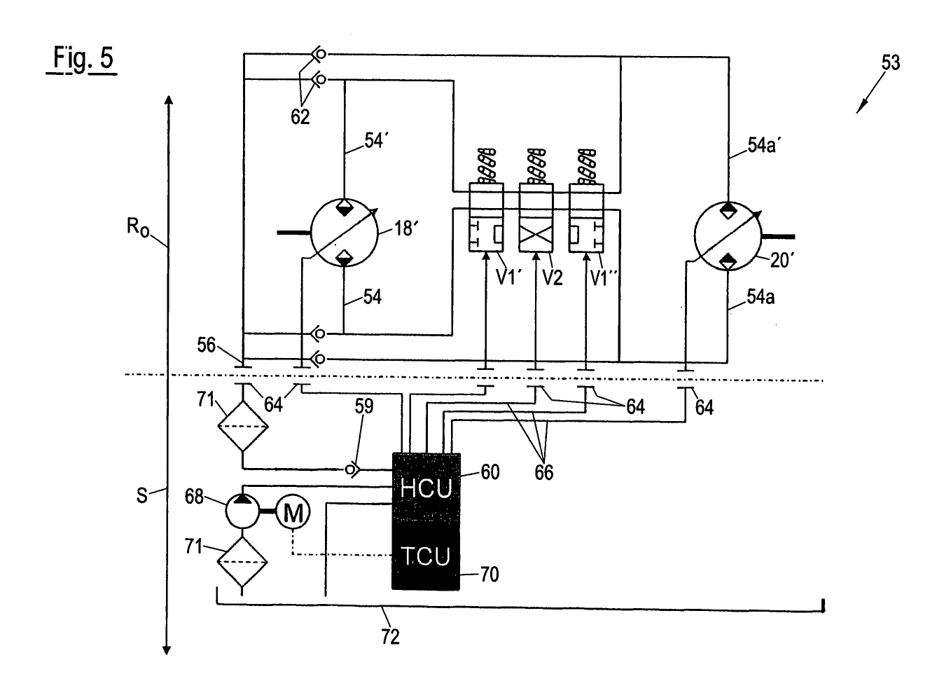

It can therefore very generally be stated that balanced states can be generated with the help of variable hydrostatic machines 18′, 20′ and a suitable combination of gear stages on a hydraulic coupling of the hydrostatic machines 18′, 20′, said balanced states ultimately having the effect of additional transmission ratios. Such shift transmissions can therefore be used very flexibly and versatilely. The use of variable hydrostatic machines 18′, 20′ for the carrying out of a gear stage change will be explained in the following with reference to FIG. 5.

Such balanced states can, however, also be generated with a fixed geometry of the hydrostatic machines, with the adopted state then corresponding to the fixedly set respective volume throughput per revolution of the hydrostatic machines.

FIG. 5 shows an embodiment of the pressure control 53 of a variant of the shift transmission 10 with variable hydrostatic machines 18′, 20′. A gear stage change in this respect takes place in a substantially analog manner, as described above with reference to FIG. 3. The variable hydrostatic machine 20′ is, however, configured before the hydraulic coupling of the hydrostatic machines 18′, 20′ such that its fluid volume throughput per revolution, that is its volume displacement per revolution, is smaller than the corresponding fluid volume throughput per revolution of the hydrostatic machine 18′ if this were not blocked. The fluid volume throughput per revolution of the hydrostatic machine 20′, which is operated as a pump in the starting state, is in particular very small so that the quantity of the hydraulic fluid circulated in the idling state is small.

After the second gear stage has been selected and after the two hydrostatic machines 18′, 20′—switch states of the valves V1′, V1″ and V2 as shown in FIG. 3—have been hydraulically coupled to one another, the fluid volume throughput per revolution of the hydrostatic machine 20′ is generally raised, whereas the rotational speed of the input shaft is reduced. During the conveying capacity increase of the hydrostatic machine 20′, the fluid volume throughput per revolution of the hydrostatic machine 18′ operated as a motor in this state remains constant. In this situation, an increasing torque transfer takes place via the second transmission branch 28 associated with the hydrostatic machine 20′, while the torque transferred via the first transmission branch 26 falls by the same amount. With amounts of the torques transferred via the two mechanical transmission branches 26, 28 of equal size, the balanced state described with reference to FIG. 3 is substantially present.

On a further lowering of the rotational speed, the fluid volume throughput per revolution of the hydrostatic machine 18′ is reduced in the continued coupled state of the hydrostatic machines 18′, 20′, while the fluid volume throughput per revolution of the hydrostatic machine 20′ remains constant or is increased even further. More and more torque is thereby transferred via the second mechanical transmission branch 28. A substantially complete torque transfer from the first transmission branch 26 to the second transmission branch 28 is reached when the drive rotational speed has reached the rotational speed level of the second transmission branch 28. To conclude the shift procedure, the hydrostatic machine 20′ is then blocked by an actuation of the valve V 1″ and the hydrostatic machine 18′ is simultaneously short-circuited by the valve V1′.

The respective fluid volume throughput per revolution, i.e. the respective geometry of the two hydrostatic machines 18′, 20′ can also be varied simultaneously or with time overlap on this gear stage change.

The above-described variant of the shift transmission 10 having variable hydrostatic machines 18′, 20′ allows even smoother gear stage changes. In addition, the above-described concepts can be realized with respect to a geared creep and to a hydraulic reverse gear as well as with respect to a plurality of intermediate gear changes.

The embodiment of the pressure control 53 shown in FIG. 5 has no outflow line 58. Consequently, there is also no valve V3 arranged in the extent of the outflow line 58, no regulable restrictor D and no cooling device 74. These components can, however, generally also be integrated in the embodiment shown in FIG. 5.

All discussed embodiments of the pressure control 53 can be in communication with further components of a hydraulic system. For example, the pressure lines 54, 54′, 54a, 54a′ can be connectable via a switch-in valve (not shown) to an all-wheel drive clutch (AWD clutch) to actuate it. An effective monitoring of the pressure state of the hydrostatic machines 18, 18′, 20, 20′ is also possible by such a connection.

It must still be noted with respect to the above-explained respective pressure control 53 that the switch valves (V1, V2, V3) can have suitable control edges to effect soft transitions between the different switch states.

In addition, a “fail-safe” function is preferably realized. As can be seen from the arrangement of respective compression springs in accordance with FIGS. 3 to 5, the valves (V1, V1′, V″, V2 and V3) of the pressure control 53 are automatically brought into an open position in the case of an operational failure (switching the hydraulic control unit pressure free) to switch the transmission load free.

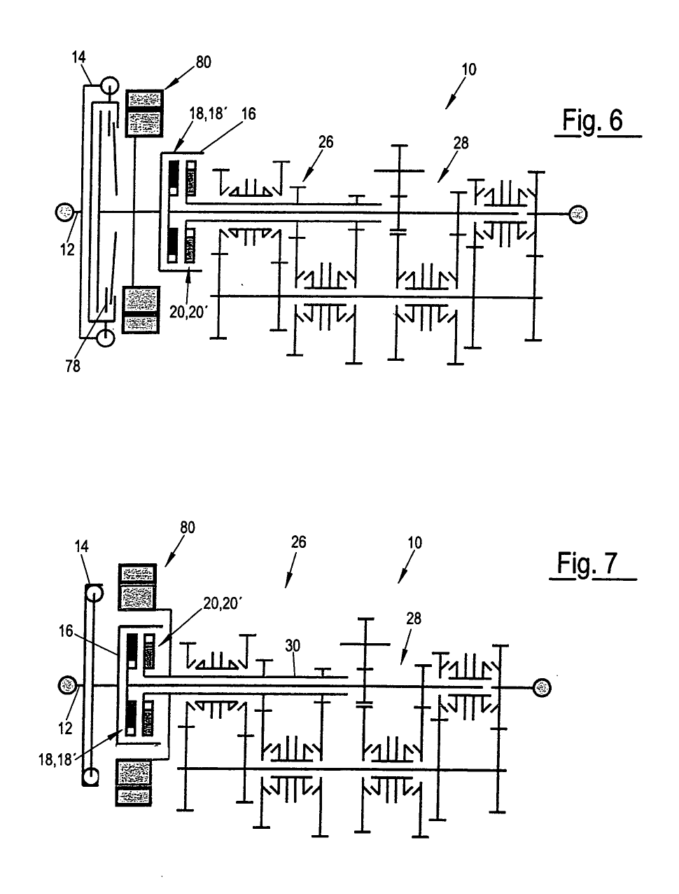

FIG. 6 shows that the shift transmission 10 can also be combined with a hybrid drive in a simple manner. The part of the shift transmission 10 from the housing 16 to the right corresponds to the embodiment which was discussed above with reference to FIG. 1. To the left of this, the torsion damper 14 is in turn provided which is, however, combined with a clutch 78. The shift transmission 10 can thereby be separated from the drive unit (not shown) so that a driving torque can be generated on the housing 16 by an electrical drive unit 80. The electrical drive unit 80 can also be used as a generator on braking for the generation of electrical energy.

FIG. 7 shows a further embodiment of the shift transmission 10 which again corresponds in large parts to the embodiment shown in FIG. 1. The rotor of the electrical drive unit or of the generator 80 is here rotationally fixedly coupled to the hollow shaft 30 of the first transmission branch 26. In this case, the clutch 78 can be dispensed with.

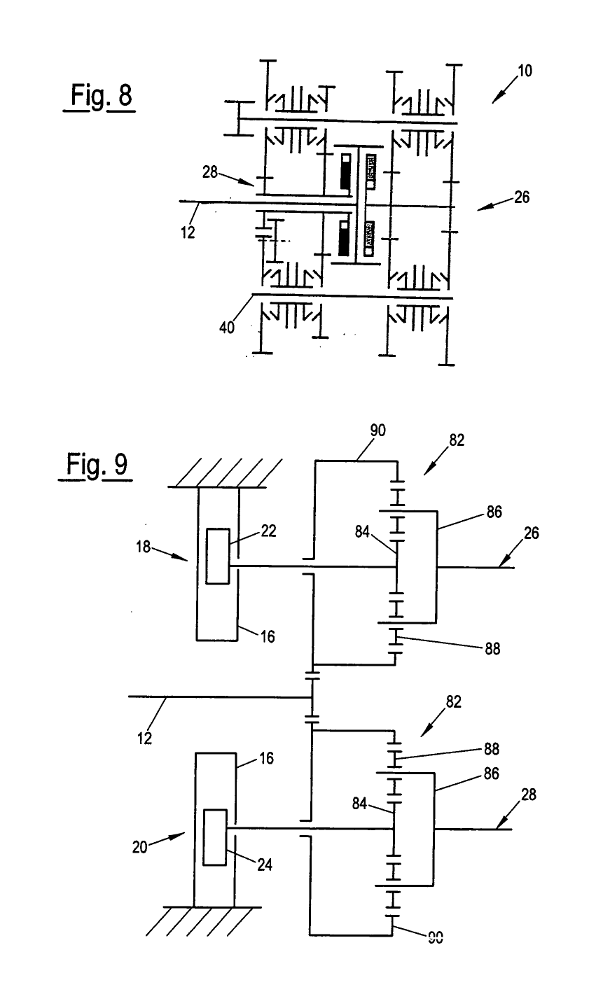

FIG. 8 shows a further embodiment of the shift transmission 10, wherein the hydrostatic machines 18, 18′, 20, 20′ are arranged between mechanical transmission branches 26, 28. This embodiment can also be combined with a hybrid drive in a simple manner.

FIG. 9 shows a further application possibility of the hydrostatic machines 18, 18′, 20, 20′ in accordance with the idea underlying the invention. The hydrostatic machines 18, 18′, 20, 20′ here do not have any common housing rotationally fixedly connected to the input shaft 12. The respective housing 16 of the pumps 18, 18′, 20, 20′ is instead fastened in a stationary manner, that is it does not rotate. The driving torque of the input shaft 12 is transferred via planetary transmissions 82 to the mechanical transmission branches 26, 28. A sun gear 84 of the respective planetary transmission 82 is here rotationally fixedly connected to the rotor 22 or 24 of the associated pump 18, 18′, 20, 20′. The mechanical transmission branches 26, 28 are rotationally fixedly coupled to a respective planetary carrier 86 at which planetary gears 88 are rotationally journalled. The driving torque of the input shaft 12 is transferred to a respective annular gear 90. The planetary gears 88 mesh with the respective sun gear 84 and with the respective annulus gear 90. The planetary transmissions 82 can naturally also be configured differently than described here by way of example.

In this embodiment, the rotors 22, 24 act so-to-say as “brakes” with which the respective sun gears 84 can be braked or held firmly. The planetary transmissions 82 thus act as differential gears for the transfer of a driving torque of the input shaft 12. If one of the pumps 18, 18′, 20, 20′ is hydraulically blocked and if the other is hydraulically short-circuited, the driving torque of the input shaft 12 is transferred completely via the mechanical transmission branch 26 and 28 respectively associated with the blocked pump 18, 18′, 20, 20′. This embodiment can likewise be controlled by the pressure control 53 which was described above with reference to FIGS. 3 to 5. However, advantages result in a construction respect since the housings 16 do not rotate, which, for example, simplifies the guidance of the control lines 68.

The foregoing description of the exemplary embodiments has been provided for purposes of illustration and description. It is not intended to be exhaustive or to limit the inventions. Individual elements or features of a particular embodiment are generally not limited to that particular embodiment but, where applicable, are interchangeable and can be used in a selected embodiment even if not specifically shown or described. The same may also be varied in many ways. Such variations are not intended to be regarded as a departure from the invention, and all modifications are intended to be included within the scope of the invention.

### REFERENCE NUMERAL LIST

shift transmission
12 input shaft
14 torsion damper
16 housing
18, 18′, 20, 20′ hydrostatic machine
22, 24 rotor
26, 28 mechanical transmission branch
30 hollow shaft
32 synchronizing device
34 transmission shaft
G1-G7, R transmission gears
r, 38 gear
36 back gear shaft
40 output shaft
44 center of the rotor
46 axis of rotation
48 piston
50 piston space
51a-e cylinder
52, 52′ valve
53 pressure control
54, 54′, 54a, 54a′ pressure line
56 supply line
58 outflow line
59 check valve
60 hydraulic control unit
62 check valve
64 rotary leadthrough
66 control line
68 pump
70 transmission control unit
71 hydraulic fluid filter
72 sump
74 cooling device
78 clutch
80 electrical drive unit
82 planetary transmission
84 sun gear
86 planet carrier
88 planetary gear
90 annulus gear
V1, V1′, V1″,
V2, V3, valve
D restrictor valve
M motor
Ro rotating region
S stationary region

1. A shift transmission having an input shaft, a first and a second mechanical transmission branch which can be coupled drive-wise to the input shaft at the input side and via different gear stages to a common output shaft at the output side, and having a first and a second hydrostatic machine which each have a primary part, a secondary part and a first and a second pressure space, wherein the primary part and the secondary part of the respective hydrostatic machine are rotatable relative to one another; wherein the secondary part of the first hydrostatic machine is operatively connected to the first mechanical transmission branch and the secondary part of the second hydrostatic machine is operatively connected to the second mechanical transmission branch; and wherein at least one pressure control device is associated with the hydrostatic machines, by means of which the first pressure space of the first hydraulic machine can be selectively hydraulically coupled to the first pressure space of the second hydrostatic machine and, hydraulically separate therefrom, the second pressure space of the first hydrostatic machine can be selectively hydraulically coupled to the second pressure space of the second hydrostatic machine to bring about a pressure balance between the two hydrostatic machines.

2. The shift transmission in accordance with claim 1, wherein the two hydrostatic machines can be hydraulically coupled to one another such that the one hydrostatic machine hydraulically drives the other hydrostatic machine.

3. The shift transmission in accordance with claim 1, wherein the two hydrostatic machines can be directly hydraulically coupled without interposed restrictive members and/or interposed check valves.

4. The shift transmission in accordance with claim 1, wherein one of the hydrostatic machines is selectively hydraulically blockable by means of the pressure control device to connect the respective secondary part substantially rotationally fixedly to the primary part of the respective hydrostatic machine.

5. The shift transmission in accordance with claim 1, wherein one of the hydrostatic machines can selectively be hydraulically short-circuited by means of the pressure control device to decouple the respective primary part from the secondary part of the respective hydrostatic machine.

6. The shift transmission in accordance with claim 1, wherein the pressure control device is controllable such that a driving torque transferred via the input shaft is selectively transferred either in accordance with a selected gear stage only to the first mechanical transmission branch or is transferred in accordance with another selected gear stage only to the second mechanical transmission branch or is transferred at least in part to the two mechanical transmission branches.

7. The shift transmission in accordance with claim 1, wherein the secondary parts of the hydrostatic machines are connected to the respective mechanical transmission branch without interposition of friction clutches.

8. The shift transmission in accordance with claim 1, wherein each of the two hydrostatic machines can selectively be operated as a hydrostatic pump or as a hydrostatic motor.

9. The shift transmission in accordance with claim 1, wherein the pressure control device can be controlled such that one of the hydrostatic machines is operated at least at times as a hydraulic pump, whereas the other hydrostatic machine is simultaneously operated as a hydrostatic motor which is driven by the one hydrostatic machine.

10. The shift transmission in accordance with claim 1, wherein a control unit is provided by means of which the pressure control device and a gear stage actuator can be controlled for a gear stage change when a gear stage of the first mechanical transmission branch is selected, such that:
a gear stage of the second mechanical transmission branch is selected, while the first hydrostatic machine is hydraulically blocked and the second hydrostatic machine is hydraulically short-circuited;
then the first and second hydrostatic machines are hydraulically coupled to one another and the rotational speed of the input shaft is reduced, with a pressure balance taking place between the two hydrostatic machines and the driving torque being transferred at least in part via the second mechanical transmission branch; and
then the first and second hydrostatic machines are hydraulically decoupled from one another, with the second hydrostatic machine being hydraulically blocked and the first hydrostatic machine being hydraulically short-circuited so that the driving torque is substantially completely transferred by the second mechanical transmission branch.

11. The shift transmission in accordance with claim 10, wherein the rotational speed of the input shaft is controllable such that it is further reduced while the first and second hydrostatic machines are hydraulically decoupled from one another.

12. The shift transmission in accordance with claim 1, wherein the geometry of the hydrostatic machines is variable such that a volume throughput of a hydraulic fluid can be set which flows through the respective hydrostatic machine per revolution of the secondary part relative to the corresponding primary part.

13. The shift transmission in accordance with claim 10, wherein the pressure device and the geometry of the hydrostatic machines are controllable such that;
the volume throughput per revolution of the second hydrostatic machine is smaller before the hydraulic coupling of the hydrostatic machines than the corresponding volume throughput per revolution of the first hydrostatic machine; and
the volume throughput per revolution of the second hydrostatic machine is increased during the hydraulic coupling of the hydrostatic machines and the volume throughput per revolution of the first hydrostatic machine is reduced until the driving torque is primarily or substantially completely transferred via the second mechanical transmission branch.

14. The shift transmission in accordance with claim 1, wherein the first pressure space of the first hydrostatic machine can be hydraulically the second pressure space of the second hydrostatic machine and, hydraulically separate from this, the second pressure space of the first hydrostatic machine can be hydraulically coupled to the first pressure space of the second hydrostatic machine.

15. shift transmission in accordance with claim 1, wherein the geometry of the hydrostatic machines is fixed or controllable such that a positive or negative transmission ratio is set between the input shaft and the output shaft which is smaller in amount than the transmission ratio of the lowest gear stage, while gear stages with transmission ratios of the same sense or of the opposite sense are selected in the mechanical transmission branches and the first pressure space of the first hydrostatic machine is hydraulically coupled to the second pressure space of the second hydrostatic machine and the second pressure space of the first hydrostatic machine is hydraulically coupled to the first pressure space of the second hydrostatic machine.

16. The shift transmission in accordance with claim 1, wherein the respective primary part and the respective secondary part of the hydrostatic machines are rotatable.

17. The shift transmission in accordance with claim 1, wherein the primary part of the first, hydrostatic machine is rotationally fixedly connected to the primary part of the second hydrostatic machine, is in particular formed in one piece with the primary part of the second hydrostatic machine.

18. The shift transmission in accordance with claim 1, wherein the input shaft is coupled drive-wise to the respective primary part of the hydrostatic machines.

19. The shift transmission in accordance with claim 1, wherein a respective differential gear is associated with both mechanical transmission branches, with an input of the respective differential gear being coupled to the input shaft, a first output being coupled to the secondary part of the respective hydrostatic machine and a second output being coupled to the respective mechanical transmission branch.

20. The shift transmission in accordance with claim 19, wherein the respective differential gear is formed by a planetary transmission.

21. The shift transmission in accordance with claim 19, wherein the primary parts of the hydrostatic machines are arranged stationary.

22. The shift transmission in accordance with claim 19, wherein the input shaft and the first and second mechanical transmission branches are permanently coupled to one another.

23. The shift transmission in accordance with claim 1, wherein an electrical machine is coupled drive-wise to the primary part or to the secondary part of at least one of the two hydrostatic machines.

24. The shift transmission in accordance with claim 1, wherein at least one of the two hydrostatic machines can be hydraulically connected to at least one further component of a hydraulic system.

25. The shift transmission in accordance with claim 1, wherein the pressure control device has a 4/3 way valve.

26. The shift transmission in accordance with claim 1, wherein a connection line in whose extent a controllable restrictor valve is arranged to restrict the fluid throughput of the respective hydrostatic machine is associated with each of the hydrostatic machines.

27. The shift transmission in accordance with claim 26, wherein a common connection line and a common restrictor valve are associated with the hydrostatic machines.

28. The shift transmission in accordance with claim 26, wherein a cooling device for the cooling of the hydraulic fluid is arranged in the extent of the connection line.
